(19) United States
(12) Patent Application Publication
(10) Pub. No.: US 2009/0153479 A1
(43) Pub. Date: Jun. 18, 2009

(54) Positioning Device of Pointer and Related Method

(76) Inventors: Ren-Hau Gu, Hsin-Chu City (TW); Tzu-Yi Chao, Hsin-Chu City (TW); Chih-Hsin Lin, Hsin-Chu City (TW)

Correspondence Address: NORTH AMERICA INTELLECTUAL PROPERTY CORPORATION, P.O. BOX 506, MERRIFIELD, VA, 22116, US

(21) Appl. No.: 12/242,948

(22) Filed: Oct. 1, 2008

(30) Foreign Application Priority Data
Dec. 17, 2007 (TW) 096148243

(51) Int. Cl. G06F 3/033

(52) U.S. Cl. 345/158

(57) ABSTRACT

A positioning device for positioning an aim point of a pointer on a screen includes a screen, a pointer and a processor. The screen is utilized for displaying a plurality of characteristic points having already-known coordinate values. The pointer is utilized for forming an aim point, and includes an image acquisition unit for acquiring an image and a calculation unit for calculating image coordinate values of the plurality of characteristic points in the image. The processor is coupled to the screen and the pointer, and is utilized for establishing a transformation matrix according to the already-known coordinate values of the plurality of characteristic points and the image coordinate values of the plurality of characteristic points in the image and for deciding the position of the aim point according to the transformation matrix.

### BACKGROUND OF THE INVENTION

1. Field of the Invention

The present invention relates to a positioning device of a pointer and related method, and more particularly, to a positioning device and related method for deciding a location of an aim point pointed at by the pointer on a screen and relative positions of the pointer itself by a plurality of characteristic points with known coordinate values displayed on the screen.

2. Description of the Prior Art

Video games played on television sets or personal computers have become popular leisure activities. To provide players of video games with more lively and interesting game experiences, game consoles are often equipped with interactive control devices. For example, pointing devices, such as a light gun, or motion sensing devices, such as a joystick, allow the game consoles to respond to locations of aim points laid by the pointing devices, or to motions sensed by the motion sensing devices. In this case, precise positioning of the location of the aim point, and precise sensing of the motions (e.g. rotations or movements) applied by the players to the motion sensing devices, become more and more important. Some conventional measures are described briefly in the following.

A pointing device, e.g. an optical gun, is disclosed in US patent publication No. US2003078105, entitled “Visual feedback system for optical guns,” in which a counter and a sensor with small visual angle are included. When an electron gun in a scanning display scans to an aim point laid by the optical gun on the screen, the optical gun detects the scanning signal and calculates coordinate values of the aim point (i.e. positioning the aim point) according to synchronization signals and a counting value of a counter. However, this measure is only suitable for scanning-type displays that have the scanning signals, but is not applicable to current flat panel displays, such as liquid crystal displays (LCDs), plasma display panels (PDPs), etc.

A positioning device of a pointer is also disclosed in TW Patent No. 588258, entitled “Device for pointer positioning using photography method”, which captures an image of a whole display area of a screen with a camera, and performs edge-rendering and identification processes on the captured image. Coordinate values of four corners of the display area and of a center point in the captured image can then be obtained for further calculating actual coordinate values of the aim point on the screen (i.e. a focus of the camera), so that the positioning operation can be performed without the limitation on the screen type. However, the image captured by the camera also includes video content displayed in the display area, and thus the operation of identifying the four corners of the display area is easily affected by the video content, such that the aim point may be positioned inaccurately. Additionally, since the image captured by the camera must contain the whole display area of the screen, the positioning device disclosed in TW Patent No.588258 requires a camera with a large visual angle.

A positioning system is further disclosed in US patent publication No. US20050107160, entitled “Photographic Pointer Positioning System and Its Operation Process,” which is different from the above positioning device in arranging an extra reference symbol which facilitates the edge-rendering and identification processes performed on the captured image, so that coordinate values of the aim point on the display area may be calculated more efficiently. Similarly, difficulties in identifying the four corners of the display area still exist, and a camera with a large visual angle is still needed.

Finally, a positioning device of a pointer is disclosed in US patent publication No. 2006258465, entitled “Orientation device and method for coordinate generation employed thereby,” which arranges a plurality of reference marks on a display plane for supporting the positioning operation of the aim point. Since the reference marks are light objects capable of being detected, the positioning device can easily identify each of the reference marks on the captured image to avoid the identification difficulties occurring in the above-mentioned methods. However, before the positioning operation, the positioning device has to perform a calibration process, in which four corners of the screen are individually aimed at by the camera to generate coordinate values of the four corners of the screen corresponding to a reference coordinate plane, and a transformation matrix that maps the reference coordinate plane to a normalized coordinate plane can then be obtained for the positioning operation.

Although the identification difficulties are greatly improved, the positioning device disclosed in US patent publication No. 2006258465 still needs the extra reference marks and complicates the calibration process. In addition, the prior art does not teach how to position the motions (e.g. rotations or panning) of the motion sensing devices, or the relative positions of the pointing device itself.

### SUMMARY OF THE INVENTION

It is therefore a primary objective of the present invention to provide a positioning device of a pointer and related method.

According to the present invention, a positioning device for positioning an aim point on a screen pointed at by a pointer comprises a screen, a pointer and a processor. The screen is utilized for displaying a plurality of characteristic points with known screen coordinate values. The pointer is utilized for pointing at a position on the screen and forming an aim point at the position, and comprises an image acquisition unit for acquiring an image according to the position of the aim point on the screen, wherein a center point of the image corresponds to the position of the aim point on the screen; and a calculation unit for detecting the plurality of characteristic points in the image and calculating image coordinate values of the plurality of characteristic points in the image. The processor is coupled to the screen and the pointing apparatus, and comprises a transformation matrix generation unit for establishing a transformation matrix according to the known screen coordinate values of the plurality of characteristic points and the image coordinate values of the plurality of characteristic points in the image; and a position decision unit for converting coordinate values of the center point of the image to those of the aim point on the screen for deciding the position of the aim point on the screen according to the transformation matrix.

According to the present invention, a positioning method for positioning an aim point on a screen pointed by a pointer comprises displaying a plurality of characteristic points with known screen coordinate values on a screen; forming an aim point at a position on the screen pointed at by the pointer; acquiring an image according to the position of the aim point on the screen, wherein a center point of the image corresponds to the position of the aim point on the screen; detecting the plurality of characteristic points in the image and calculating image coordinate values of the plurality of characteristic points in the image; establishing a transformation matrix according to the known screen coordinate values of the plurality of characteristic points and the image coordinate values of the plurality of characteristic points in the image; and converting coordinate values of the center point of the image to those of the aim point on the screen for deciding the position of the aim point on the screen according to the transformation matrix.

According to the present invention, a positioning device for an image sensor comprises a screen, an image sensor and a processor. The screen is utilized for displaying a plurality of characteristic points with known screen coordinate values. The image sensor is utilized for acquiring an image, and comprises a calculation unit for detecting the plurality of characteristic points in the image and calculating image coordinate values of the plurality of characteristic points in the image. The processor is coupled to the screen and the image sensor, and comprises a projection matrix generation unit for establishing a projection matrix according to the known screen coordinate values of the plurality of characteristic points and the image coordinate values of the plurality of characteristic points in the image; and a position decision unit for computing a position and a direction of the image sensor relative to a screen coordinate system according to the projection matrix.

According to the present invention, a positioning method for an image sensor comprises displaying a plurality of characteristic points with known screen coordinate values on a screen; acquiring an image for detecting the plurality of characteristic points in the image and calculating image coordinate values of the plurality of characteristic points in the image; establishing a projection matrix according to the known screen coordinate values of the plurality of characteristic points and the image coordinate values of the plurality of characteristic points in the image; and computing a position and a direction of the image sensor relative to a screen coordinate system according to the projection matrix.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a positioning device of a pointer according to the present invention.

FIG. 2 and FIG. 3 are schematic diagrams of embodiments of characteristic points according to the present invention.

FIG. 4 is a schematic diagram of a positioning process of a pointer according to the present invention.

FIG. 5 is a schematic diagram of an embodiment of the positioning process according to the present invention.

FIG. 6 is a schematic diagram of a positioning device of an image sensor according to the present invention.

FIG. 7 is a schematic diagram of a positioning process of an image sensor according to the present invention.

FIG. 8 is a schematic diagram of an embodiment of the positioning process of FIG. 7 according to the present invention.

### DETAILED DESCRIPTION

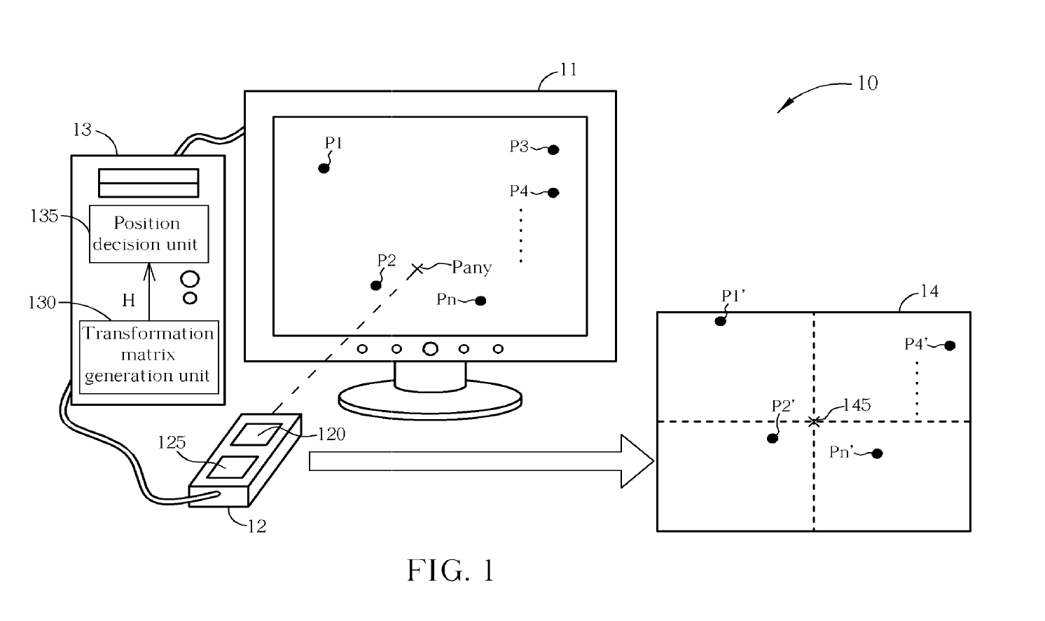

Please refer to FIG. 1. FIG. 1 is a schematic diagram of a positioning device 10 of a pointer according to the present invention. The positioning device 10 is utilized for positioning a location of an aim point on a screen pointed at by the pointer, and includes a screen 11, a pointer 12 and a processor 13. The screen 11 is utilized for displaying characteristic points P1 to Pn, which have known screen coordinate values. The pointer 12 is utilized for aiming at a location on the screen 11 and forming an aim point Pany at the location, and includes an image acquisition unit 120 and a calculation unit 125. The image acquisition unit 120 can be an image sensor, like a CMOS sensor, and is utilized for acquiring an image 14 according to the location of the aim point Pany on the screen 11. A center point 145 of the image 14 corresponds to the location of the aim point Pany on the screen 11. The calculation unit 125 is utilized for detecting characteristic points P1′ to Pn′, individually corresponding to the characteristic points P1 to Pn, in the image 14, and calculating image coordinate values of the characteristic points P1′ to Pn′ in the image 14. The processor 13 is coupled to the screen 11 and the pointer 12, and includes a transformation matrix generation unit 130 and a position decision unit 135. The transformation matrix generation unit 130 is utilized for establishing a transformation matrix H according to the known screen coordinate values of the characteristic points P1 to Pn and the image coordinate values of the characteristic points P1′ to Pn′ in the image 14. The position decision unit 135 is utilized for converting image coordinate values of the center point 145 in the image 14 to screen coordinate values of the aim point Pany to decide the position of the aim point Pany on the screen 11 by the transformation matrix H.

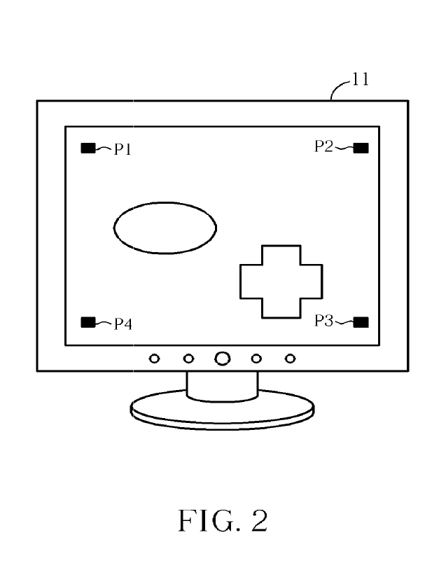

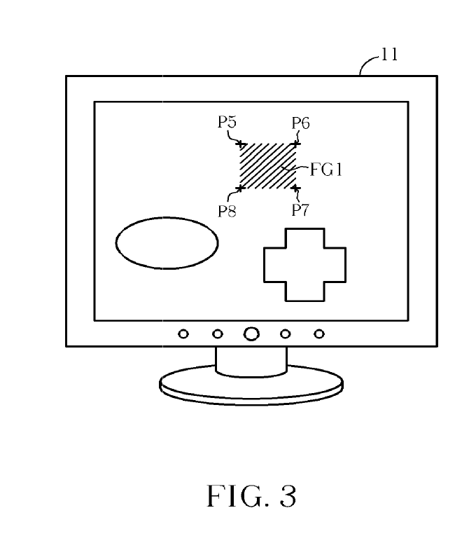

Preferably, the characteristic points P1 to Pn are points with specific colors or are corners of specific geometric figures displayed on the screen 11. For example, please refer to FIG. 2 and FIG. 3. In FIG. 2, characteristic points P1 to P4 are points with specific colors displayed at four corners of the screen 11, and in FIG. 3, characteristic points P5 to P8 are four corners of a specific geometric figure FG1 displayed on the screen 11. Thus, any objects capable of being identified easily and displayed on the screen 11 all belong to the range of the present invention. In addition, coordinate values of the characteristic points P1 to Pn can be decided by the processor 13 in advance and stored in a storage unit (not shown in FIG. 1), and the characteristic points P1 to Pn can vary with images displayed in the screen 11, such as being corners of moving objects in an animation.

Therefore, by identifying the characteristic points in the captured image, the present invention can calculate the image coordinate values of the characteristic points in the image, and establish a transformation matrix based on the characteristic points with already-known coordinate values on the screen, so that the coordinate values of the center point in the image can be converted to the screen coordinate values of the aim point accordingly. Since the characteristic points can be points directly displayed in the video, and have easily identified properties, the present invention need not set up additional reference marks. In addition, the coordinate values of the characteristic points are determined before being displayed on the screen, and thus the present invention can generate the transformation matrix immediately for positioning the aim point without performing a calibration process in advance.

Please note that the positioning device 10 of the pointer can be a computer, a game console, etc., the screen 11 can be a computer screen, a flat panel display like a liquid crystal display (LCD) or a plasma display panel (PDP) or a projection screen of a projector, and the pointer can be a light gun or a computer mouse, which are not restricted herein.

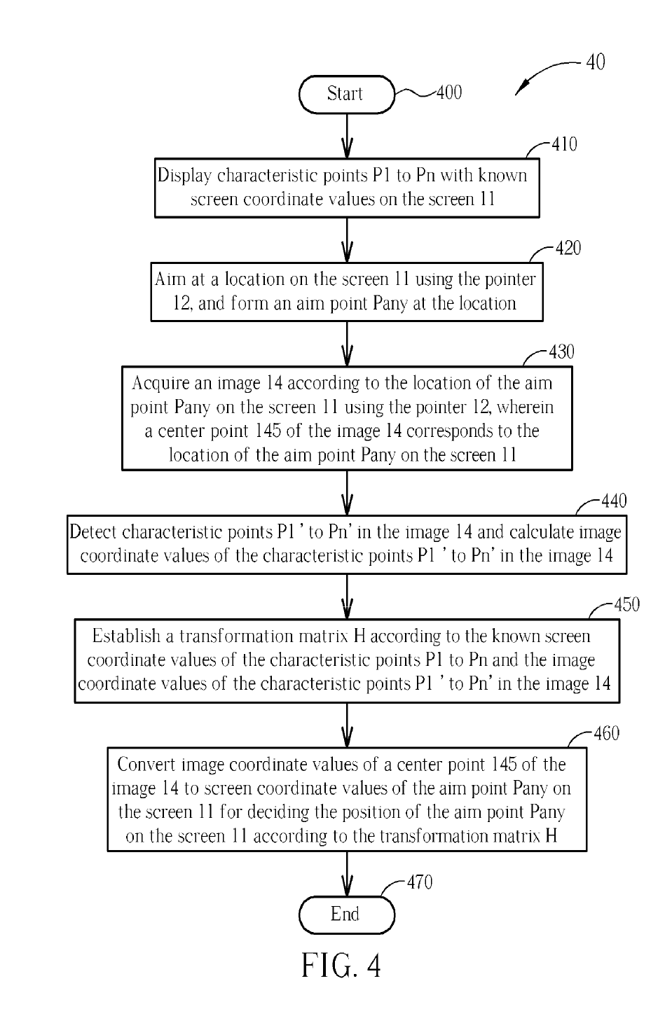

Please refer to FIG. 4. FIG. 4 is a schematic diagram of a positioning process 40 of a pointer according to the present invention. The positioning process 40 is an operating process of the positioning device 10 of the pointer, and includes the following steps:

Step 400: Start.

Step 410: Display characteristic points P1 to Pn with known screen coordinate values on the screen 11.

Step 420: Aim at a location on the screen 11 using the pointer 12, and form an aim point Pany at the location.

Step 430: Acquire an image 14 according to the location of the aim point Pany on the screen 11 using the pointer 12, wherein a center point 145 of the image 14 corresponds to the location of the aim point Pany on the screen 11.

Step 440: Detect characteristic points P1′ to Pn′ in the image 14 and calculate image coordinate values of the characteristic points P1′ to Pn′ in the image 14.

Step 450: Establish a transformation matrix H according to the known screen coordinate values of the characteristic points P1 to Pn and the image coordinate values of the characteristic points P1′ to Pn′ in the image 14.

Step 460: Convert image coordinate values of a center point 145 of the image 14 to screen coordinate values of the aim point Pany on the screen 11 for deciding the position of the aim point Pany on the screen 11 according to the transformation matrix H.

Step 470: End.

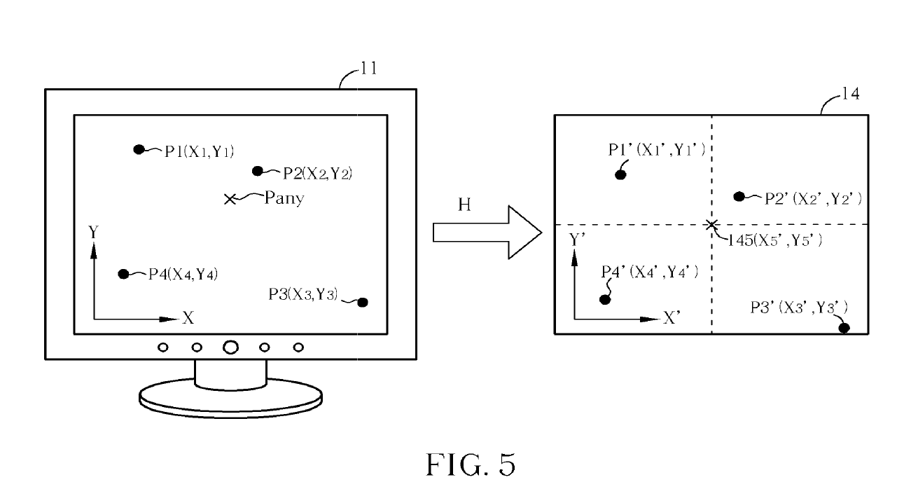

Please further refer to FIG. 5. FIG. 5 is a schematic diagram of an embodiment of the positioning process 40 according to the present invention. In FIG. 5, the present invention first displays characteristic points P1 to P4 on the screen 11, among which screen coordinate values are (X1,Y1), (X2,Y2), (X3,Y3) and (X4,Y4), respectively. Then, the pointer 12 aims at a position of the screen 11 (i.e. an aim point Pany), and captures an image 14, wherein a center point 145 of the image 14 corresponds to the position of the aim point Pany on the screen 11. The calculation unit 125 of the pointer 12 then identifies characteristic points P1′ to P4′ in the image 14, and calculates image coordinate values of the characteristic points P1′ to Pn′ in the image 14, which are (X1′,Y1′), (X2′,Y2′), (X3′,Y3′) and (X4′,Y4′), respectively. Thus, the processor 13 can generate a transformation matrix H according to the screen coordinate values of the characteristic points P1 to P4 and the image coordinate values of the characteristic points P1′ to P4′ in the image 14. For example, the present invention can respectively form a first matrix A and a second matrix B using the screen coordinate values of the characteristic points P1 to P4 and the image coordinate values of the characteristic points P1′ to P4 in the image 14, and can thus obtain inner coefficients of the transformation matrix H by the relationship A=H*B, so as to establish the transformation matrix H. Finally, the processor 13 can convert image coordinate values (X5′,Y5′) of the center point 145 in the image 14 to screen coordinate values of the aim point Pany for deciding the position of the aim point Pany on the screen 11. So far, the positioning process of the aim point Pany is completed. Note that the number of the characteristic points is not restricted to four, which can be modified according to practical demands, but in order to precisely position the aim point Pany, the number of the characteristic points is at least two. The related mathematical operation of the transformation matrix H is well known by those skilled in the art, and thus not narrated herein.

Therefore, by identifying the characteristic points in the captured image, the present invention can calculate the image coordinate values of the characteristic points in the image and establish a transformation matrix based on the characteristic points with already-known coordinate values on the screen, so that the coordinate values of the center point in the image can be converted to the screen coordinate values of the aim point accordingly. In this case, the present invention can directly position the aim point of the pointer without setting up additional reference marks and performing a calibration process in advance.

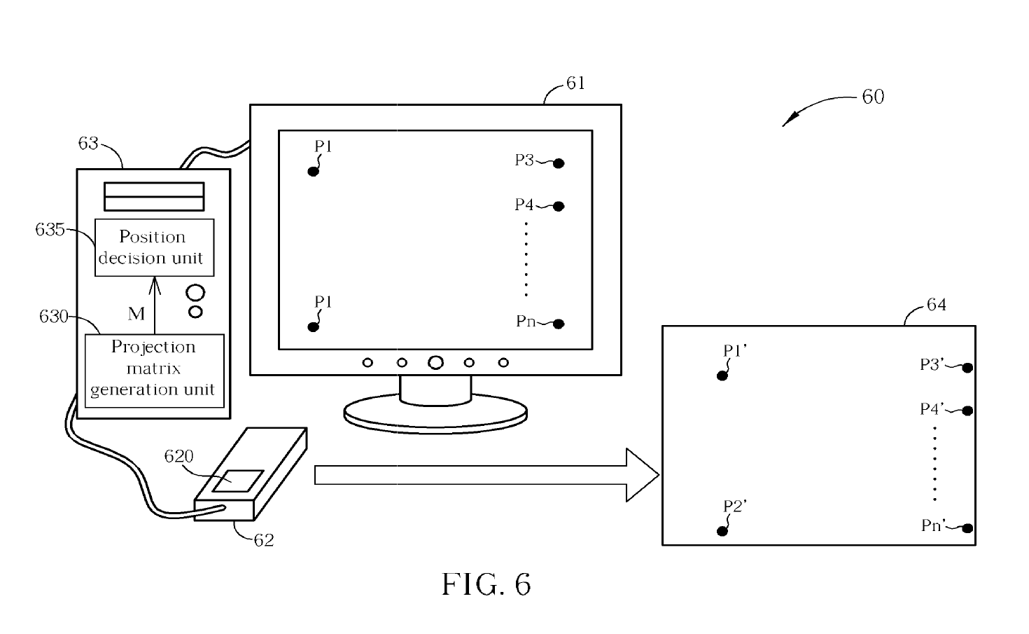

Besides, by utilizing the characteristic points with known coordinate values displayed on the screen, the relative position of the pointer itself can also be determined in the present invention. Please refer to FIG. 6. FIG. 6 is a schematic diagram of a positioning device 60 of an image sensor according to the present invention. The positioning device 60 of the image sensor is similar to the positioning device 10 of the pointer in FIG. 1, and includes a screen 61, an image sensor 62 and a processor 63. The screen 61 is utilized for displaying characteristic points P1 to Pn with known screen coordinate values. The image sensor 62, similar to the pointer 12 in FIG. 1, is utilized for acquiring an image 64, and includes a calculation unit 620. The calculation unit 620 is utilized for identifying characteristic points P1′ to Pn′ in the image 64 and calculating image coordinate values of the characteristic points P1′ to Pn′ in the image 64. The processor 63 is coupled to the screen 61 and the image sensor 62, and includes a projection matrix generation unit 630 and a position decision unit 635. The projection matrix generation unit 630 is utilized for establishing a projection matrix M according to the known screen coordinate values of the characteristic points P1 to Pn and the image coordinate values of the characteristic points P1′ to Pn′ in the image 64. The position decision unit 635 is utilized for computing a position and a direction of the image sensor 62 relative to the screen 61 according to the projection matrix M.

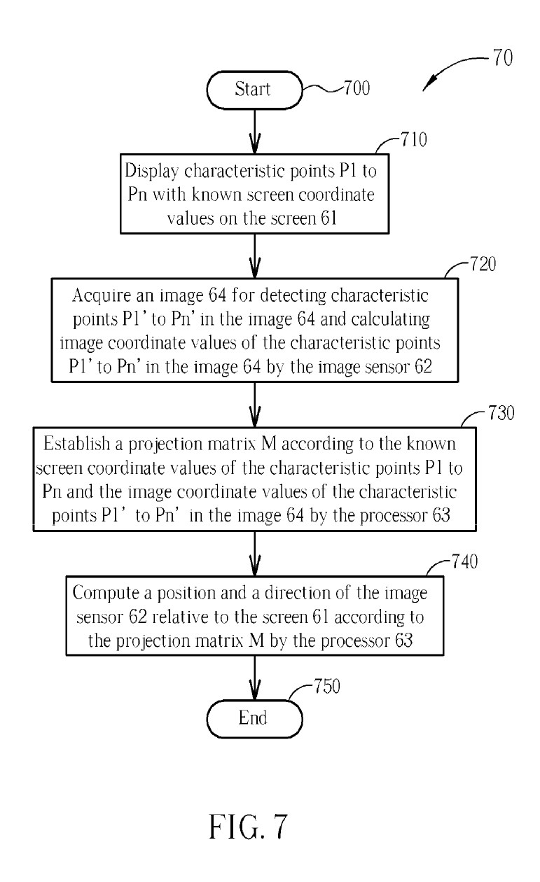

Thus, by utilizing the characteristic points with the known screen coordinate values, relative coordinate values of the image sensor 62 can further be obtained for determining motions of the image sensor 62 relative to the screen 61 in the present invention. Please refer to FIG. 7. FIG. 7 is a schematic diagram of a positioning process 70 of an image sensor according to the present invention. The positioning process 70 is an operating process of the positioning device 60, and includes the following steps:

Step 700: Start.

Step 710: Display characteristic points P1 to Pn with known screen coordinate values on the screen 61.

Step 720: Acquire an image 64 for detecting characteristic points P1′ to Pn′ in the image 64 and calculating image coordinate values of the characteristic points P1′ to Pn′ in the image 64 by the image sensor 62.

Step 730: Establish a projection matrix M according to the known screen coordinate values of the characteristic points P1 to Pn and the image coordinate values of the characteristic points P1′ to Pn′ in the image 64 by the processor 63.

Step 740: Compute a position and a direction of the image sensor 62 relative to the screen 61 according to the projection matrix M by the processor 63.

Step 750: End.

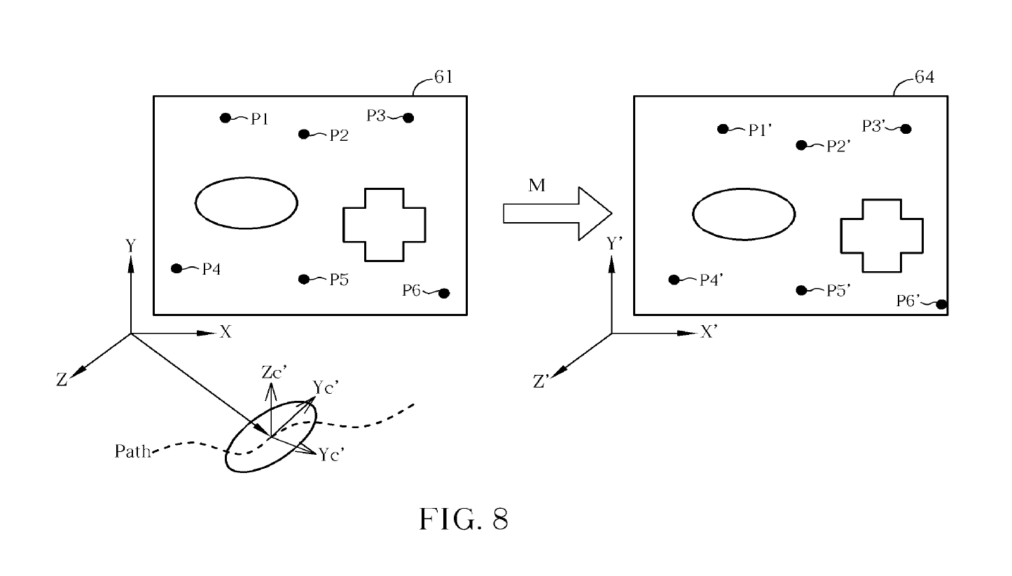

Please further refer to FIG. 8. FIG. 8 is a schematic diagram of an embodiment of the positioning process 70 according to the present invention. In FIG. 8, coordinate systems of the screen 61, the image sensor 62, and the image 64 captured by the image sensor 62 are represented by X-Y-Z, Xc-Yc-Zc and X′-Y′-Z′, respectively. As is well known by those skilled in the art, by performing the perspective projection, the coordinate values corresponding to the coordinate system of the image sensor 62 can be converted to those corresponding to the coordinate system of the image 64 through an intrinsic matrix Mᵢₙₜ. The intrinsic matrix Mᵢₙₜ can be expressed as

$${M}_{int} = [ \begin{matrix}{f}_{x} & 0 & {c}_{x} \\ 0 & {f}_{y} & {c}_{y} \\ 0 & 0 & 1\end{matrix} ] ,$$

among which fₓ and f_{y} respectively represent focal lengths of an X axis and a Y axis of the image sensor 62, and Cₓ and C_{y} respectively represent focus offsets of the image sensor 62 from the X axis and the Y axis. On the other hand, an extrinsic matrix Mₑₓₜ can be obtained by shifting and rotating the coordinate system of the image sensor 62, so that the coordinate values corresponding to the coordinate system of the screen 61 can be converted to those corresponding to the coordinate system of the image sensor 62. The extrinsic matrix Mₑₓₜ can be expressed as:

$${M}_{ext} = [ \begin{matrix}{r}_{11} & {r}_{12} & {r}_{13} & {T}_{x} \\ {r}_{21} & {r}_{22} & {r}_{23} & {T}_{y} \\ {r}_{31} & {r}_{32} & {r}_{33} & {T}_{z}\end{matrix} ] ,$$

among which r₁₁ to r₃₃ respectively represent rotation angles of the image sensor 62, and Tₓ, T_{y} and T_{z} respectively represent displacements corresponding to each axis of the image sensor 62. Thus, through a projection matrix M formed by the intrinsic matrix Mᵢₙₜ and the extrinsic matrix Mₑₓₜ, the coordinate values corresponding to the coordinate system of the screen 61 can be converted to those corresponding to the coordinate system of the image 64, wherein the projection matrix M can be expressed as M=Mᵢₙₜ*Mₑₓₜ.

Thus, interior coefficients of the projection matrix M can then be obtained for establishing the projection matrix M by the known screen coordinate values of the characteristic points P1 to P6 and the image coordinate values of the characteristic points P1′ to P6 in the image 64. The related mathematical operation is well known by those skilled in the art and not narrated herein. Finally, the processor 63 can calculate interior coefficients of the extrinsic matrix Mₑₓₜ for obtaining the rotation angles and the displacements of the image sensor 62 according to the projection matrix M, so that the position and the direction of the image sensor 62 relative to the screen 11 can be determined. Note that, in order to decide the relative coordinate values of the image sensor 62, the number of the characteristic points is at least six.

Therefore, by the known coordinate values of the characteristic points on the screen and the coordinate values of the characteristic points in the image, the present invention can generate a projection matrix to determine the position and the direction of the image sensor 62 relative to the screen 61. Note that the embodiments hereinabove are merely exemplary illustrations of the present invention, but not limitations of the present invention. For example, another embodiment of the present invention can appropriately combine the pointer in FIG. 1 and the image sensor in FIG. 6 for realizing a game control device, which not only can position the aim point of the pointer, but can also determine the relative coordinate values or the motions, such as rotations or movements of the pointer itself.

As mentioned above, by the known coordinate values of the characteristic points displayed on the screen, the present invention not only can position the aim point pointed by the pointer at the screen, but can also determine the relative position of the pointer itself. In addition, since the characteristic points are points directly displayed on the screen and have easily identified properties, the present invention need not set up additional reference marks. On the other hand, the coordinate values of the characteristic points are determined before being displayed on the screen, and thus the present invention can position the aim point without performing a calibration process in advance, so as to significantly enhance the convenience of use.

Those skilled in the art will readily observe that numerous modifications and alterations of the device and method may be made while retaining the teachings of the invention.

What is claimed is:

1. A positioning device for positioning an aim point on a screen comprising:
a screen for displaying a plurality of characteristic points with known screen coordinate values;
a pointer, for pointing at a position on the screen and forming an aim point at the position, the pointer comprising:
an image acquisition unit for acquiring an image according to the position of the aim point on the screen, wherein a center point of the image corresponds to the position of the aim point on the screen; and
a calculation unit for detecting the plurality of characteristic points in the image and calculating image coordinate values of the plurality of characteristic points in the image; and
a processor, coupled to the screen and the pointing apparatus, comprising:
a transformation matrix generation unit for establishing a transformation matrix according to the known screen coordinate values of the plurality of characteristic points and the image coordinate values of the plurality of characteristic points in the image; and
a position decision unit for converting coordinate values of the center point of the image to those of the aim point on the screen for deciding the position of the aim point on the screen according to the transformation matrix.

2. The positioning device of claim 1, wherein the plurality of characteristic points are displayed as corners of specific geometric figures on the screen.

3. The positioning device of claim 1, wherein the plurality of characteristic points have specific colors.

4. The positioning device of claim 1, wherein the plurality of characteristic points have specific shapes.

5. The positioning device of claim 1, wherein the number of the plurality of characteristic points is at least two.

6. The positioning device of claim 1, wherein the plurality of characteristic points vary with different images.

7. The positioning device of claim 1, wherein the pointing apparatus is a light gun.

8. The positioning device of claim 1, wherein the pointing apparatus is a computer mouse.

9. A positioning method for positioning an aim point on a screen pointed by a pointer comprising:
displaying a plurality of characteristic points with known screen coordinate values on a screen;
forming an aim point at a position on the screen pointed at by the pointer;
acquiring an image according to the position of the aim point on the screen, wherein a center point of the image corresponds to the position of the aim point on the screen;
detecting the plurality of characteristic points in the image and calculating image coordinate values of the plurality of characteristic points in the image;
establishing a transformation matrix according to the known screen coordinate values of the plurality of characteristic points and the image coordinate values of the plurality of characteristic points in the image; and
converting coordinate values of the center point of the image to those of the aim point on the screen for deciding the position of the aim point on the screen according to the transformation matrix.

10. The positioning method of claim 9, wherein the plurality of characteristic points are displayed as corners of specific geometric figures on the screen.

11. The positioning method of claim 9, wherein the plurality of characteristic points have specific colors.

12. The positioning method of claim 9, wherein the plurality of characteristic points have specific shapes.

13. The positioning method of claim 9, wherein the number of the plurality of characteristic points is at least two.

14. The positioning method of claim 9, wherein the plurality of characteristic points vary with different images.

15. The positioning method of claim 9, wherein the pointer is a light gun.

16. The positioning method of claim 9, wherein the pointer is a computer mouse.

17. A positioning device for an image sensor comprising:
a screen for displaying a plurality of characteristic points with known screen coordinate values;
an image sensor, for acquiring an image, the image sensor comprising:
a calculation unit for detecting the plurality of characteristic points in the image and calculating image coordinate values of the plurality of characteristic points in the image; and
a processor, coupled to the screen and the image sensor, comprising:
a projection matrix generation unit for establishing a projection matrix according to the known screen coordinate values of the plurality of characteristic points and the image coordinate values of the plurality of characteristic points in the image; and
a position decision unit for computing a position and a direction of the image sensor relative to a screen coordinate system according to the projection matrix.

18. The positioning device of claim 17, wherein the plurality of characteristic points are displayed as corners of specific geometric figures on the screen.

19. The positioning device of claim 17, wherein the plurality of characteristic points have specific colors.

20. The positioning device of claim 17, wherein the plurality of characteristic points have specific shapes.

21. The positioning device of claim 17, wherein the number of the plurality of characteristic points is at least six.

22. The positioning device of claim 17, wherein the plurality of characteristic points vary with different images.

23. The positioning device of claim 17, wherein the projection matrix comprises an extrinsic matrix and an intrinsic matrix.

24. The positioning device of claim 23, wherein the position decision unit computes the position and the direction of the image sensor relative to the screen coordinate system according to the extrinsic matrix.

25. The positioning device of claim 17, wherein the image sensor is installed in a light gun.

26. The positioning device of claim 17, wherein the image sensor is installed in a game control device.

27. A positioning method for an image sensor comprising:
displaying a plurality of characteristic points with known screen coordinate values on a screen;
acquiring an image for detecting the plurality of characteristic points in the image and calculating image coordinate values of the plurality of characteristic points in the image;
establishing a projection matrix according to the known screen coordinate values of the plurality of characteristic points and the image coordinate values of the plurality of characteristic points in the image; and
computing a position and a direction of the image sensor relative to a screen coordinate system according to the projection matrix.

28. The positioning method of claim 27, wherein the plurality of characteristic points are displayed as corners of specific geometric figures on the screen.

29. The positioning method of claim 27, wherein the plurality of characteristic points have specific colors.

30. The positioning method of claim 27, wherein the plurality of characteristic points have specific shapes.

31. The positioning method of claim 27, wherein the number of the plurality of characteristic points is at least six.

32. The positioning method of claim 27, wherein the plurality of characteristic points vary with different images.

33. The positioning method of claim 27, wherein the projection matrix comprises an extrinsic matrix and an intrinsic matrix.

34. The positioning method of claim 33, wherein computing the position and the direction of the image sensor relative to the screen coordinate system according to the projection matrix is computing the position and the direction of the image sensor relative to the screen coordinate system according to the extrinsic matrix.

35. The positioning method of claim 27, wherein the image sensor is installed in a light gun.

36. The positioning method of claim 27, wherein the image sensor is installed in a game control device.
